(19) United States
(12) Patent Application Publication
(10) Pub. No.: US 2019/0331166 A1
(43) Pub. Date: Oct. 31, 2019

(54) Longer Lasting Roller Bearing

(71) Applicant: Walter Harry Geisel, III, Denver, CO (US)

(72) Inventor: Walter Harry Geisel, III, Denver, CO (US)

(21) Appl. No.: 15/967,366

(22) Filed: Apr. 30, 2018

(51) Int. Cl. F16C 19/50

(52) U.S. Cl. CPC F16C 19/505; F16C 2240/70; F16C 2300/02

(57) ABSTRACT

Between the races of a roller bearing, paired inner and outer rollers allow a clockwork like rotation to cut friction and extend life.

### BACKGROUND

Modern roller bearings are very good but keep rollers in place with seats, separators or a cage and use lubricants to allow slippage. Working machinery generally need new bearings every year or two.

### SUMMARY

Between concentric races my bearing uses a second ring of rollers to keep rollers in place and share the load evenly across rollers.

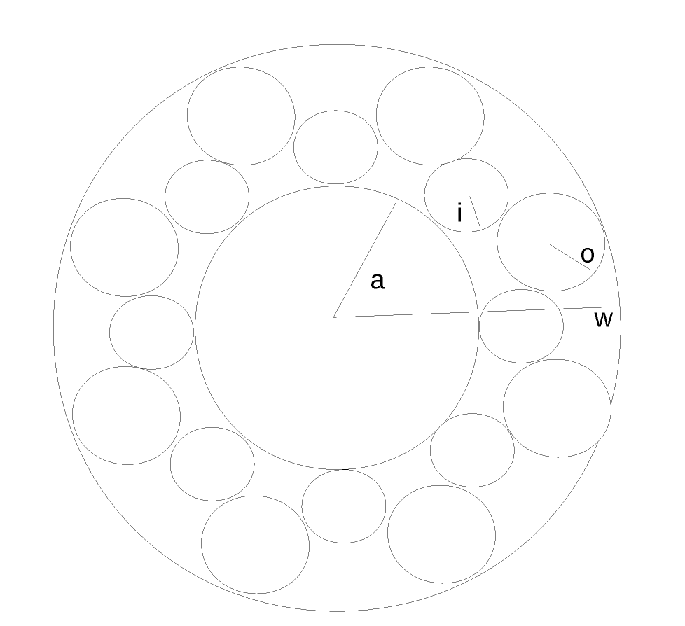

FIG. 1/1 described: End View Drawing illustrates how the double ring of rollers alternate between a center or Axle race and outer or Wheel race. In this example, n=8 pairs of rollers.

Roller and race size relationships are contained in the equation:

(i+o)²=(w−o)²+(a+i)²−2(w−o)(a+i) cos(II/n)

where:
a=the radius of the center race surface or Axle
w=the radius of the outer race surface or Wheel
i=the radius of each Inner ring roller
o=the radius of each Outer ring roller
n=Number of pairs of inner and outer rollers

While radii have been more useful in development, note that this equation may substitute diameters. Note that typical diameter measurements of bearings will have to add in the thickness of the races.

When selecting sizes for a bearing that is well hung, check that inner rollers don't touch, outer rollers don't touch or allow an opposing roller to drop through.

The limits for the inner roller gap are: 0<2(a+i)sin(II/n)−2i<2o

The limits for the outer roller gap are: 0<2(w−o)sin(II/n)−2o<2i

All rollers should be of equal length to avoid unequal wear. In assembly, final parts may need a slight rotation to seat firmly. End caps, race lips, matching groove and ridge or magnets may keep rollers aligned on the races.

1. With very close tolerances, I claim this roller bearing should be very long lasting.
